(19) United States
(12) Patent Application Publication
(10) Pub. No.: US 2011/0223359 A1
(43) Pub. Date: Sep. 15, 2011

(54) HYDROTHERMAL SYNTHESIS OF LiFePO4 NANOPARTICLES

(75) Inventors: Lu Yang, Milpitas, CA (US); Eric H. Liu, Los Altos, CA (US); Abraham Anapolsky, San Mateo, CA (US)

(73) Assignee: APPLIED MATERIALS, INC., Santa Clara, CA (US)

(21) Appl. No.: 13/026,038

(22) Filed: Feb. 11, 2011

Related U.S. Application Data
(60) Provisional application No. 61/304,006, filed on Feb. 12, 2010.

(51) Int. Cl. H01M 4/04; B05D 5/12; B05C 9/14; B05C 11/00; H01M 4/86; H01B 1/22; H01B 1/24; B82Y 40/00; B82Y 30/00

(52) U.S. Cl. 427/595; 118/620; 252/182.1; 252/519.3; 252/506; 977/892; 977/932

(57) ABSTRACT

Embodiments of the present invention generally relate to lithium-ion batteries, and more specifically, to a method of fabricating such batteries using thin-film deposition processes. In one embodiment In one embodiment, a method of forming a film on a substrate is provided. The method comprises combining a lithium-containing precursor, an iron containing precursor, and an organic solvent to form a deposition mixture, optionally exposing the deposition mixture to vibrational energy, applying microwave energy to the deposition mixture to heat the deposition mixture, optionally exposing the heated deposition mixture to vibrational energy, and depositing the heated deposition mixture on a substrate to form a film comprising lithium containing nanocrystals.

### CROSS-REFERENCE TO RELATED APPLICATIONS

This application claims benefit of U.S. provisional patent application Ser. No. 61/304,006, filed Feb. 12, 2010, which is herein incorporated by reference.

### BACKGROUND OF THE INVENTION

1. Field of the Invention

Embodiments of the present invention relate generally to lithium-ion batteries, and more specifically, to a method of fabricating such batteries using thin-film deposition processes.

2. Description of the Related Art

Fast-charging, high-capacity energy storage devices, such as supercapacitors and lithium (Li) ion batteries, are used in a growing number of applications, including portable electronics, medical devices, transportation, grid-connected large energy storage, renewable energy storage, and uninterruptible power supplies (UPS). In modern rechargeable energy storage devices, the current collector is made of an electric conductor. Examples of materials for the positive current collector (the cathode) include aluminum, stainless steel, and nickel. Examples of materials for the negative current collector (the anode) include copper (Cu), stainless steel, and nickel (Ni). Such collectors can be in the form of a foil, a film, or a thin plate, having a thickness that generally ranges from about 6 to 50 μm.

Graphite is usually used as the active electrode material of the negative electrode and can be in the form of a lithium-intercalation meso-carbon micro beads (MCMB) powder made up of MCMBs having a diameter of approximately 10 μm. The lithium-intercalation MCMB powder is dispersed in a polymeric binder matrix. The polymers for the binder matrix are made of thermoplastic polymers including polymers with rubber elasticity. The polymeric binder serves to bind together the MCMB material powders to preclude crack formation and prevent disintegration of the MCMB powder on the surface of the current collector. The quantity of polymeric binder is in the range of 2% to 30% by weight.

The active electrode material in the positive electrode of a Li-ion battery is typically selected from lithium transition metal oxides, such as LiMn₂O₄, LiCoO₂, LiNiO₂, or combinations of Ni, Li, Mn, and Co oxides and includes electroconductive particles, such as carbon or graphite, and binder material. Such positive electrode material is considered to be a lithium-intercalation compound, in which the quantity of conductive material is in the range from 0.1% to 15% by weight.

The lithium transition metal oxide, such as LiCoO₂, is one of the more expensive components of traditional Li-ion batteries. LiCoO₂ is also toxic and can lead to problems such as runaway overheating and outgassing, making batteries that use it susceptible to fire. LiFePO₄, which does not suffer from the aforementioned deficiencies of LiCoO₂, is a compound that has gained increased attention for use in Li-ion batteries. LiFePO₄ batteries do not experience the overheating and outgassing problems that LiCoO₂ batteries experience, and as a result, do not require as intense charge monitoring as traditional Li-ion batteries. Further, both phosphorous and iron are abundantly available thus yielding a lower price for raw materials.

Various methods such as sol-gel processing, emulsion drying, and hydrothermal processing have been proposed for producing LiFePO₄. However, the majority of these procedures require a final heating step of several hours at high temperature in an inert or reductive atmosphere to yield LiFePO₄ in crystal phase. As a result, these procedures often consume large amounts of both time and energy.

For most energy storage applications, the charge time and capacity of energy storage devices are important parameters. In addition, the size, weight, and/or expense of such energy storage devices can be significant limitations.

Accordingly, there is a need in the art for faster charging, higher capacity energy storage devices that are smaller, lighter, and can be more cost effectively manufactured.

### SUMMARY OF THE INVENTION

Embodiments of the present invention generally relate to lithium-ion batteries, and more specifically, to a method of fabricating such batteries using thin-film deposition processes. In one embodiment, a method of forming a film on a substrate is provided. The method comprises combining a lithium-containing precursor, an iron containing precursor, a phosphate containing precursor, and an organic solvent to form a deposition mixture, optionally exposing the deposition mixture to vibrational energy, applying microwave energy to the deposition mixture to heat the deposition mixture, optionally exposing the heated deposition mixture to vibrational energy, and depositing the heated deposition mixture on a substrate to form a film comprising lithium containing nanocrystals.

In another embodiment, a composition for forming a lithium containing active electrode material having an olivine structure on a substrate is provided. The composition comprises a lithium-containing precursor, an iron containing precursor, a phosphate containing precursor, and an organic solvent.

In yet another embodiment, an apparatus for forming a lithium containing active electrode material having an olivine structure on a substrate is provided. The apparatus comprises a processing chamber enclosing a substrate support and a dispenser, the dispenser comprising an activation chamber in fluid communication with a precursor source, a source of electric power coupled to the activation chamber, a mixing region in fluid communication with the activation chamber for forming a deposition mixture, the mixing region having an exit oriented toward the substrate support, a lithium-containing precursor source in fluid communication with the mixing region, an iron containing precursor source in fluid communication with the mixing region, and an organic solvent in fluid communication with the mixing region.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic diagram of a Li-ion battery according to one embodiment described herein;

FIG. 2 is a flow diagram summarizing a method according to one embodiment described herein;

FIG. 3 is a schematic cross-sectional view of a film formation apparatus according to embodiments described herein;

FIG. 4 is a schematic representation of a scanning electron microscope (SEM) image of LiFePO₄ particles which have been exposed to ultrasonic treatment both before and after microwave heating; and

FIG. 5 is a plot demonstrating that phase pure LiFePO₄ has been obtained.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments disclosed herein generally provide methods and apparatus for forming a film on a substrate. In one embodiment, the film may be an electrochemical film for a thin-film battery, such as a Li-ion battery, or supercapacitor device having a lithium containing active electrode material having an olivine crystal structure (LiMPO₄ where M refers to any metal or combination of metals including Fe, Co, Ni, and Mn).

Different from the two traditional cathode materials—LiMn₂O₄ and LiCoO₂, lithium ions of LiMPO₄ move in the one-dimensional free volume of the lattice. During charge/discharge, the lithium ions are extracted from/inserted into LiMPO₄ while the central iron ions are oxidized/reduced. This extraction/insertion process is reversible. In theory, LiMPO₄ has a charge capacity of about 170 mAh/g and a stable open-circuit voltage of 3.45V. For example, the insertion/extraction reaction of the lithium ions in LiFePO₄ is as follows:

LiFe(II)PO₄ [symbol] Fe(III)PO₄+Li+e⁻ (1)

The extraction of lithium from LiFePO₄ produces FePO₄ with similar structures. Extraction of lithium ions reduces the lattice volume, as is also the case for lithium oxides. On the other hand, a nearly close-packed hexagonal oxygen atom array provides a relatively small free volume for lithium ion motion and therefore, lithium ions in the lattice have small migration speeds at ambient temperature. During charge, lithium ions and corresponding electrons are extracted from the structure, and a new phase of FePO₄ and a new phase interface are formed. During discharge, lithium ions and the corresponding electrons are inserted back into the structure and a new phase of LiMPO₄ is formed outside the FePO₄ phase. Hence, the lithium ions of cathode particles have to go through an inward or an outward structural phase transition, be it extraction or insertion. A phase interface forms between LiₓFePO₄ phases and Li₁₋ₓFePO₄ phases. As the migration of lithium ions proceeds, the surface area of the interface changes, expanding as insertion of lithium creates more LiₓFePO₄ phases and shrinking as extraction of lithium creates more Li₁₋ₓFePO₄ phases. When a threshold surface area is reached, the electrons and ions of the resulting FePO₄ have low conductivity and two-phase structures are formed. Thus, LiMPO₄ at the center of the particle will not be fully consumed, especially under the condition of large discharge current.

The lithium ions move in the one-dimensional channels in the olivine structures and have high diffusion constants. Theoretical calculations have shown very high lithium diffusivity of less than 1 millisecond for 50 nanometers. The limiting factor for charge/discharge is the delivery of Li-ions and electrons to the three phase interface where the active material, the electrolyte, and the current collector meet. Besides, the olivine structures experiencing multiple cycles of charge and discharge remain stable and the iron atom still resides in the center of the octahedron.

It is widely believed that the poor electronic conductivity and poor Lithium ion transportation limit the performance of LiFePO₄. It has been shown that carbon coating of LiFePO₄ helps improve the electronic conductivity so the major hurdle remains lithium ion transportation. Since lithium only moves in and out of the crystal structure through the [010] direction of the crystal, lithium must be transported along the crystal surface to be charged/discharged. It has been shown that during the charging and discharging, lithium transport occurs through the [020] surface. Thus it is desirable to produce LiFePO₄ particles dominated by the [020] surface texture.

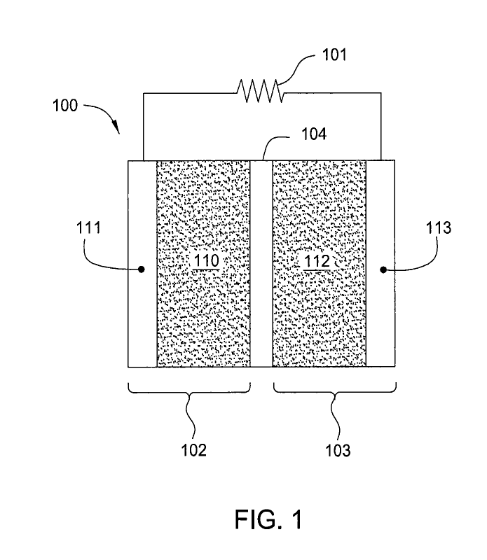

FIG. 1 is a schematic diagram of a Li-ion battery 100 electrically connected to a load 101, according to one embodiment described herein. The primary functional components of the Li-ion battery 100 include an anode structure 102, a cathode structure 103, a separator layer 104, and an electrolyte (not shown) disposed within the region between the opposing current collectors 111 and 113. A variety of materials may be used as the electrolyte, such as a lithium salt in an organic solvent. The electrolyte is contained in the anode structure 102, the cathode structure 103, and the fluid-permeable separator layer 104 in the region formed between the current collectors 111 and 113.

The anode structure 102 and the cathode structure 103 each serve as a half-cell of the Li-ion battery 100 and together form a complete working cell of Li-ion battery 100. The anode structure 102 includes a current collector 111 and a first electrolyte containing material 110, such as a carbon-based intercalation host material for retaining lithium ions. Similarly, cathode structure 103 includes a current collector 113 and a second electrolyte containing material 112, such as an iron olivine, for retaining lithium ions. The current collectors 111 and 113 are made of electrically conductive material such as metals and metal alloys. In some cases, a separator layer 104, which is a dielectric, porous, fluid-permeable layer, may be used to prevent direct electrical contact between the components in the anode structure 102 and the cathode structure 103.

The electrolyte containing material on the cathode side of the Li-ion battery 100, or positive electrode, may comprise a lithium-containing material. The electrolyte containing material may be made from iron olivine (LiFePO₄) and it is variants (such as LiFe₁₋ₓMgPO₄), LiMoPO₄, LiCoPO₄, Li₃V₂(PO₄)₃, LiVOPO₄, LiMP₂O₇, or LiFe_{1.5}P₂O₇.

The electrolyte containing material on the anode side of the Li-ion battery 100, or negative electrode, may be made from materials described above, namely graphitic microbeads dispersed in a polymer matrix. Additionally, microbeads of silicon, tin, or lithium titanate (Li₄Ti₅O₁₂) may be used with, or instead of, graphitic microbeads to provide the conductive core anode material.

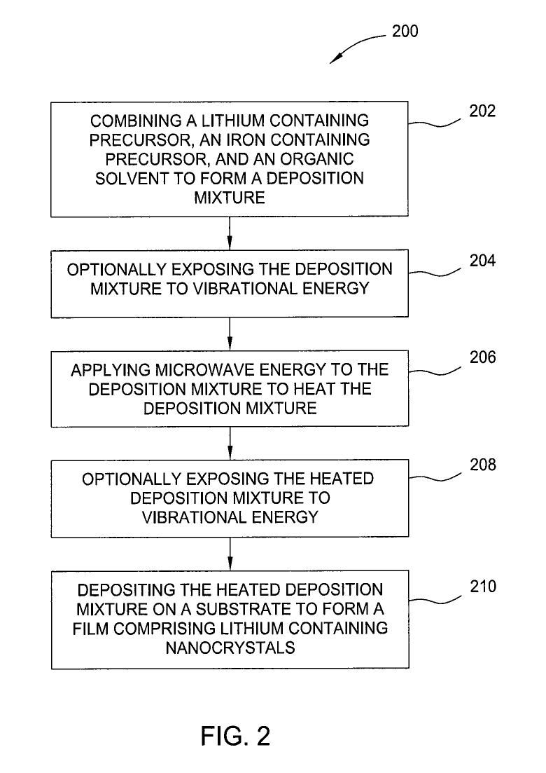

FIG. 2 is a flow diagram summarizing a method 200 according to one embodiment. The method 200 is useful for forming a layer of an electrochemical agent, such as the electrolyte containing materials and/or cathode materials described above, on a substrate. The substrate may have a surface that comprises a conductive current collector for a battery structure, as described above with respect to FIG. 1.

At block 202, a deposition mixture is formed by combining at least one of a lithium containing precursor, an organic solvent, an iron containing precursor, and a phosphate containing precursor. In certain embodiments, it should be understood that one precursor may take the place of two separate precursors. For example, LiH₂PO₄ may serve as both the lithium containing precursor and the phosphate containing precursor. In one embodiment, the lithium containing precursor is selected from the group comprising, consisting of, or consisting essentially of: LiH₂PO₄, LiOH, LiNO₃, LiCH₃COO, LiCl, Li₂SO₄, Li₃PO₄, Li(C₅H₈O₂), and combinations thereof. In one embodiment, the organic solvent is selected from the group comprising, consisting of, or consisting essentially of: water, diethylene glycol, ethylene glycol, dimethyl sulfoxide (DMSO), polyethylene glycol (PEG), other similar organic solvents, and combinations thereof. In one embodiment, the iron containing precursor is selected from the group comprising, consisting of, or consisting essentially of: iron (III) acetate (Fe(CH₃COO)₃), iron (II) acetate (Fe(CH₃COO)₂), iron (II) sulfate (FeSO₄), iron (III) chloride (FeCl₃), and combinations thereof. In one embodiment, the phosphate containing precursor is selected from the group comprising, consisting of, or consisting essentially of: ammonium phosphate ((NH₄)₃PO₄)), ((NH₄)₂HPO₄), ((NH₄)₂H₂(PO₄)), phosphoric acid (H₃PO₄), and combinations thereof. In certain embodiments, it should be understood that process conditions including, for example, the order of precursor mixing, the rate of mixing, the temperature of the time of mixing, etc., may affect the morphology of the as-deposited LiFePO₄ leading to different battery performance.

In one embodiment, the deposition mixture further comprises a carbon containing precursor. In one embodiment, the carbon containing precursor is a sugar. In one embodiment, the carbon containing precursor is selected from the group comprising, consisting of, or consisting essentially of: glucose (C₆H₁₂O₆), ascorbic acid (C₆H₈O₆), sucrose (C₁₂H₂₂O₁₁), fructose (C₆H₁₂O₆), and combinations thereof. In one embodiment, the carbon containing precursor is supplied as a separate precursor that is combined with the deposition mixture after formation of initial deposition mixture. For example, during microwave assisted hydrothermal synthesis, a deposition mixture comprising the a lithium containing precursor, an organic solvent, an iron containing precursor, and a phosphate containing precursor is exposed to the carbon containing precursor during a hydrothermal carbonization reaction to form a carbon nanocoating on the LiFePO₄ particles.

In one embodiment, the deposition mixture further comprises a surfactant for controlling particle size. In one embodiment, the surfactant is a carbon containing compound which serves as the carbon containing precursor. In one embodiment, the surfactant is a cationic surfactant, for example, cetyltrimethylammonium bromide ((C₁₆H₃₃)N(CH₃)₃Br) (CTAB). In one embodiment, the surfactant is selected from the group comprising, consisting of, or consisting essentially of: sodium lauryl sulfate (C₁₂H₂₅SO₄Na) and ammonium lauryl sulfate (CH₃(CH₂)₁₀CH₂OSO₃NH₄), cationic surfactants, cetyltrimethylammonium bromide ((C₁₆H₃₃)N(CH₃)₃Br) (CTAB), oleic acid, ascorbic acid, hydrazine, sugar, and combinations thereof.

In one embodiment, the lithium containing precursor comprises dispersed particles, which may be nanoparticles, having diameter between about 1 nm and about 100 nm, of an electrochemical material in a carrying medium. The particles generally include the components used to form the electrolyte containing materials and/or cathode materials, described above. A layer of material formed on the surface of a substrate, which contains the electrolyte containing materials, cathode and/or anode material s will be referred to below as the deposited layer. In one embodiment, the carrying medium may be a liquid that is atomized before entering a processing chamber. The carrying medium may also be selected to nucleate around the electrochemical nanoparticles to reduce attachment to the walls of the processing chamber. Suitable liquid carrying media include water and organic liquids such as alcohols or hydrocarbons. The alcohols or hydrocarbons will generally have low viscosity, such as about 10 cP or less at operating temperature, to afford reasonable atomization. In other embodiments, the carrying medium may also be a gas such as helium, argon, or nitrogen in other embodiments.

In some embodiments, it may be advantageous to use binding agents, such as carbon containing electrolyte materials, in the process of forming the deposited layer. The binding agent will generally have some electrical conductivity to avoid diminishing the performance of the deposited layer. In one embodiment, the binding agent is a carbon containing polymer having a low molecular weight. The low molecular weight polymer may have a number average molecular weight of less than about 10,000 to promote adhesion of the nanoparticles to the substrate. Exemplary binding agents include, but are not limited to, polyvinylidene difluoride (PVDF) and water-soluble binders, such as butadiene styrene rubber (BSR). Adding carbon through the carrying medium may also prevent vaporization of the electrochemical material particles during processing. Carbon may additionally be added to the deposited layer through use of the combustible mixture. If the combustible mixture comprises a stoichiometric excess of carbon, uncombusted carbon will remain in the deposited layer. If the first precursor comprises a carbon containing carrying medium, the carbon of the first precursor may contribute to a stoichiometric excess of carbon, as well. Excess of carbon may also provide a reducing environment that prevents or retards oxidation of metals.

Optionally, at block 204, the deposition mixture is exposed to vibrational energy. In one embodiment, the vibrational energy is ultrasonic energy at a frequency of less than 800 kHz, for example, between about 100 kHz and about 450 kHz. In one embodiment, the vibrational energy is megasonic energy at a frequency between 800 kHz and about 2,000 kHz, for example, about 1,000 kHz. It is believed that exposing the deposition mixture to vibrational energy reduces the agglomeration of particles within the deposition mixture and makes the particles more uniform. In one embodiment, the deposition mixture is exposed to vibrational energy for a time period from about 5 minutes to about 20 minutes. In one embodiment, the deposition mixture is exposed to vibrational energy for a time period of about 10 minutes. In one embodiment, the processes of block 202 and block 204 may occur simultaneously. In one embodiment, the processes of block 202 and block 204 may partially overlap. In one embodiment, the precursors of block 202 are exposed to vibrational energy during the mixing process. It should be understood that the exposure time to vibrational energy may vary based on such factors, for example, as the precursors used, the frequency of the vibrational energy, the temperature of the precursors, the temperature of the deposition mixture, the flow rate of the precursors, the order of precursor mixing, and the mixing procedure.

At block 206, microwave energy is applied to the deposition mixture to heat the deposition mixture and add energy to the deposition mixture to activate the deposition mixture, which is used to form nanocrystals on the surface of the substrate. The energy excites thermal motion of atoms in the particles dispersed in the deposition mixture, causing them to move to preferentially find lower energy crystal lattice positions as the deposited layer is formed on the surface of the substrate. In one embodiment, the energy may be applied through a combination of means, such as electrical and thermal means. In one embodiment, the electrical energy may be applied by directing an electric field into the deposition mixture, for example, by applying an RF varying voltage to the processing chamber. In some embodiments, the energy may be applied in two phases. For example, electrical energy may be applied in a first phase to ionize at least a portion of the first precursor. The ionized precursor may then be subjected to thermal energy in a second phase. In some embodiments, portions of the energy may be applied at power levels sufficient to form a plasma containing the first precursor.

In one embodiment, the microwave energy may be applied as part of a microwave-assisted hydrothermal synthesis process. Hydrothermal synthesis includes the various techniques of crystallizing substances from high-temperature aqueous solutions at high vapor pressures; also termed “hydrothermal method”. In one embodiment, the microwave assisted hydrothermal synthesis process is performed for a hydrothermal processing time of between about 1 minute and about 12 hours. In one embodiment, the microwave assisted hydrothermal synthesis process is performed for a hydrothermal processing time of between about 10 minutes and about 30 minutes. In one embodiment, the microwave assisted hydrothermal synthesis process is performed at a hydrothermal processing temperature of between about 100 degrees Celsius and about 400 degrees Celsius. In one embodiment, the microwave assisted hydrothermal synthesis process is performed at a hydrothermal processing temperature of between about 200 degrees Celsius and about 300 degrees Celsius. The microwave assisted hydrothermal synthesis process Hydrothermal synthesis provides several advantages, for example, low cost precursors, much shorter reaction times (˜20 minutes verses ˜20 hours for other processes), moderate reaction conditions, and the possibility for large scale batch or continuous production.

At block 208, the heated deposition mixture is optionally exposed to vibrational energy. In one embodiment, the vibrational energy is ultrasonic energy at a frequency of less than 800 kHz, for example, between about 100 kHz and about 450 kHz. In one embodiment, the vibrational energy is megasonic energy at a frequency between 800 kHz and about 2,000 kHz, for example, about 1,000 kHz.

At block 210, the heated deposition mixture is deposited on the substrate to form a film comprising lithium containing nanocrystals on the substrate. In one embodiment, the deposition mixture may be applied by either wet or dry powder application techniques. In one embodiment, the powder may be applied by powder application techniques including but not limited to sifting techniques, electrostatic spraying techniques, thermal or flame spraying techniques, fluidized bed coating techniques, slit coating techniques, roll coating techniques, and combinations thereof, all of which are known to those skilled in the art.

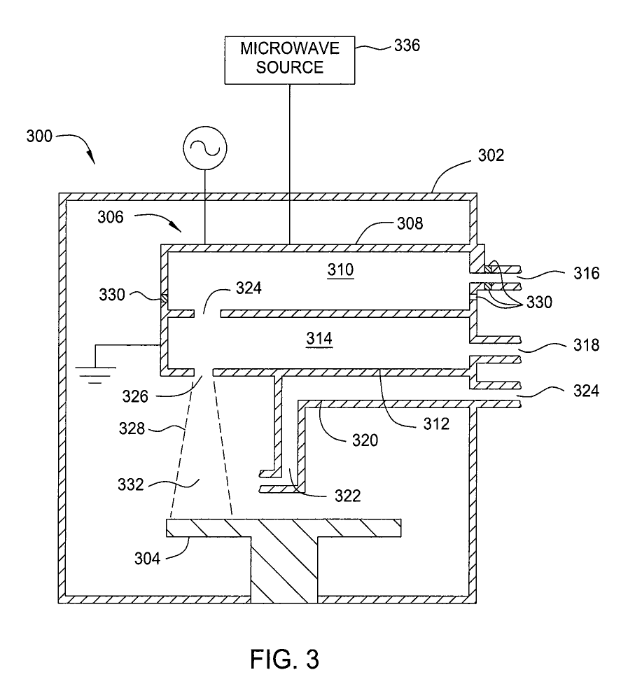

FIG. 3 is a schematic cross-sectional view of a processing chamber 300 according to one embodiment. The processing chamber 300 comprises an enclosure 302, a substrate support 304, and a dispenser 306 for providing an activated material 328 towards a substrate disposed on the substrate support 304. The dispenser 306, which may be a distributor that dispenses nanocrystals according to a certain pattern, comprises a mixing chamber 308 for forming a deposition mixture, an activation chamber 312 for activating the deposition mixture, and a conduit 320 for providing additional precursors, such as a carbon containing precursor. The mixing chamber 308 has an interior portion 310 in fluid communication with a first source conduit 316 for providing a precursor to the interior portion 310. Although only one conduit is shown, it should be understood that multiple source conduits may be coupled with the mixing chamber for supplying precursors to the mixing chamber 308. The first source conduit 316 is connected to a precursor source (not shown), which may have an atomizer for liquid precursors.

The deposition mixture in the mixing chamber 308 may be exposed to a microwave source 336 coupled with the mixing chamber 308 for heating the deposition mixture. Megasonic transducers 330 may be disposed in the walls of the dispenser 306 for exposing the deposition mixture to vibrational energy.

A first opening 324 allows the heated deposition mixture to flow from the mixing chamber 308 to the activation chamber 312. The activation chamber 312 has an interior portion 314 in fluid communication with the mixing chamber 308 and a second source conduit 318 for providing an additional precursor to the heated deposition mixture.

In one embodiment, the heated deposition mixture in the activation chamber 312 is exposed to an electric field coupled with an interior portion 314 of the activation chamber 312 by an electric source to form an activated deposition mixture. The electric source may be an RF or a DC source.

In one embodiment, a combustible mixture may be provided to the activation chamber 312 by the second source conduit 318. The combustible mixture may be ignited by the activated species in the deposition mixture, to form an activated material that is used to form the nanoparticles in the deposition mixture into nanocrystals on the substrate surface. In one configuration, precursor particles in the activated material crystallize forming nanocrystals prior to their deposition on the surface of the substrate.

The deposition mixture exits the activation chamber 312 through a second opening 326 in a spray pattern 332 that travels toward the substrate support 304 and any substrate disposed thereon. The activated material gives rise to nanocrystals deposited in a film on the substrate. In some embodiments, the nanocrystals may form before the deposition mixture reaches the substrate, while in other embodiments the nanocrystals may form after the deposition mixture reaches the substrate. The deposition mixture is derived from precursor materials that have been exposed to energy, such that particles, which may be nanoparticles, in the precursor undergo a thermal crystallization process. In some embodiments, the electric field may be extended to the mixing chamber by alternate locations of electric isolators to enhance the energetic crystallization of the particles.

The mixture that exits the dispenser 306 through the second opening 326 comprises the material 328 to be deposited on the substrate, and is carried in a gas mixture that generally comprises combustion products. The gas mixture will generally contain water vapor, carbon monoxide and dioxide, and trace quantities of vaporized electrochemical materials, such as metals. At least some of the nanocrystals may also be partially or fully coated with carbon containing material, which may be derived from combustion of the carrying medium provided with the nanoparticle precursor. In one embodiment, the gas mixture comprises a non-reactive carrier gas component, such as argon (Ar) or nitrogen (N₂) that is used to help deliver the activated material to the substrate surface.

The conduit 320 is configured to provide a second precursor to be mixed with the activated material stream impacting the substrate surface. The second precursor may be a binding agent, a filler, a conductivity enhancer, or any or all thereof. In some embodiments, the second precursor is a sprayable polymer, which may be a polymer solution or slurry, provided near the point of contact between the activated material and the substrate surface.

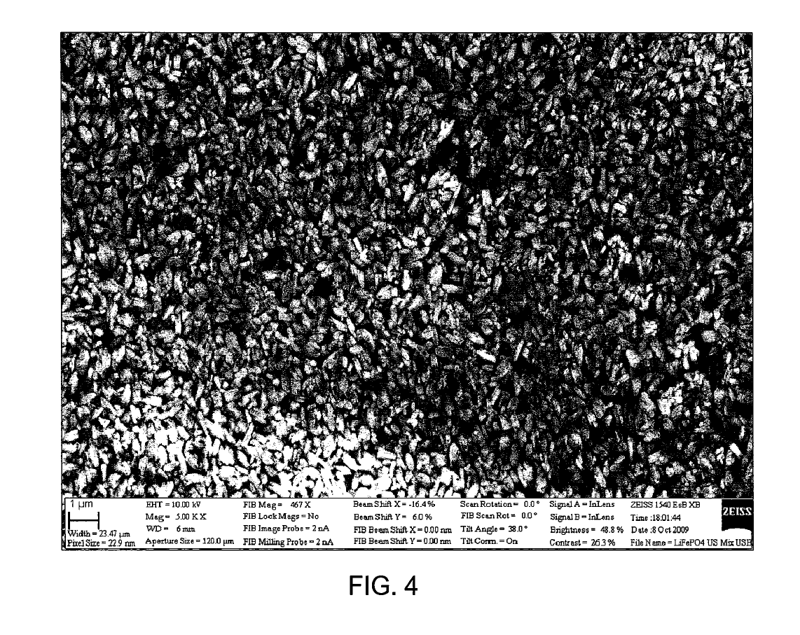

FIG. 4 is a schematic representation of a scanning electron microscope (SEM) image of LiFePO₄ particles which have been exposed to ultrasonic treatment both before and after microwave heating. As shown in FIG. 4, the size of the particles ranges is relatively uniform ranging from 200 nm to 500 nm. Also, as shown in FIG. 4, no agglomerates are observed. Thus the use of ultrasonic treatment improves the ability to control both the morphology and particle size. The presence of agglomerates reduces the energy/power performance of the particles and also increases the difficulty of using such processes as thermal spraying.

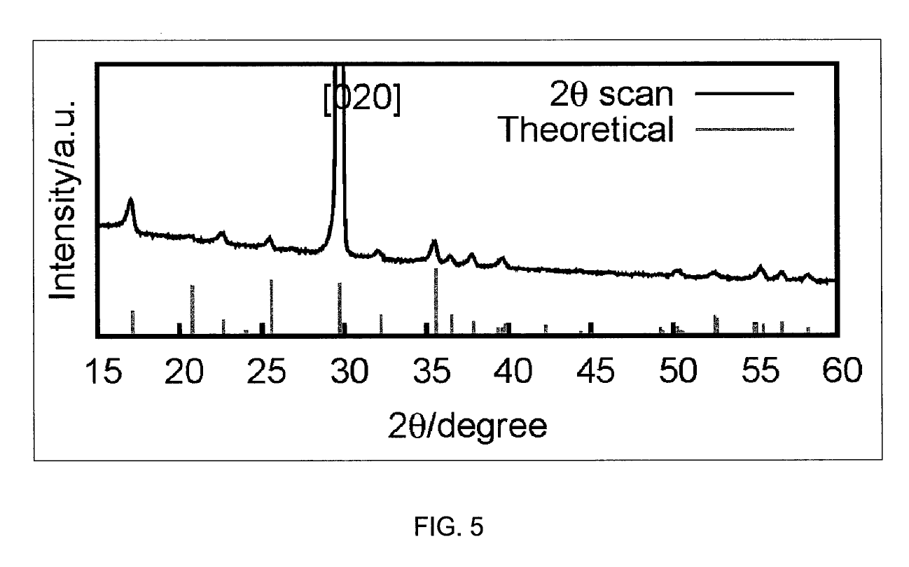

FIG. 5 is a plot demonstrating that phase pure LiFePO₄ has been obtained. FIG. 5 shows a peak height at [020] demonstrating that more than 65% of the crystals produced has the surface texture of [020].

### EXAMPLES

The following hypothetical non-limiting examples are provided to further illustrate embodiments described herein. However, the examples are not intended to be all inclusive and are not intended to limit the scope of the embodiments described herein.

### Example 1

LiFePO₄ nanoparticles were formed via hydrothermal synthesis as follows. A lithium source (LiOH), a phosphate source ((NH₄)₂HPO₄), an iron source (Fe(CH₃COO)₂), and a carbon source (glucose) were combined to form a deposition mixture. The LiFePO₄ may be formed according to the following reaction:

LiOH+(NH₄)₂HPO₄+Fe(CH₃COO)₂ [symbol] LiFePO₄+2CH₃COOH↑

The deposition mixture was exposed to ultrasonic energy at an energy level of 250 kHz. The deposition mixture was exposed to microwave irradiation for 15 minutes at 230° C. to form carbon coated LiFePO₄ via a hydrothermal carbonization reaction. The carbon coated LiFePO₄ was subsequently exposed to ultrasonic energy at an energy level of 300 kHz to reduce agglomeration. The carbon coated LiFePO₄ was deposited on an aluminum substrate via a thermal spray process at 700° C. to form a LiFePO₄/C nanocomposite film comprising lithium containing nanocrystals.

### Example 2

LiFePO₄ nanoparticles were formed via hydrothermal synthesis as follows. A lithium source (LiOH), a phosphate source (H₃PO₄), an iron source (FeCl₂), and a carbon source (glucose) were combined to form a deposition mixture. The LiFePO₄ may be formed according to the following reaction:

LiOH+H₃PO₄+FeCl₂ [symbol] LiFePO₄+H₂O+2HCl↑

The deposition mixture was exposed to ultrasonic energy at an energy level of 300 kHz. The deposition mixture was exposed to microwave irradiation for 15 minutes at 230° C. to form carbon coated LiFePO₄ via a hydrothermal carbonization reaction. The carbon coated LiFePO₄ was subsequently exposed to ultrasonic energy at an energy level of 200 kHz to reduce agglomeration. The carbon coated LiFePO₄ was deposited on an aluminum substrate via a thermal spray process at 700° C. to form a LiFePO₄/C nanocomposite film comprising lithium containing nanocrystals.

### Example 3

LiFePO₄ nanoparticles were formed via hydrothermal synthesis as follows. A lithium/ phosphate source (LiH₂PO₄), an iron source (Fe(CH₃COO)₂), and a carbon source (glucose) were combined to form a deposition mixture. The LiFePO₄ may be formed according to the following reaction:

LiH₂PO₄+Fe(CH₃COO)₂ [symbol] LiFePO₄+2CH₃COOH↑

The deposition mixture was exposed to megasonic energy at an energy level of 800 kHz. The deposition mixture was exposed to microwave irradiation for 15 minutes at 230° C. to form carbon coated LiFePO₄ via a hydrothermal carbonization reaction. The carbon coated LiFePO₄ was subsequently exposed to megasonic energy at an energy level of 850 kHz to reduce agglomeration. The carbon coated LiFePO₄ was deposited on an aluminum substrate via a thermal spray process at 700° C. to form a LiFePO₄/C nanocomposite film comprising lithium containing nanocrystals.

While the foregoing is directed to embodiments of the present invention, other and further embodiments of the invention may be devised without departing from the basic scope thereof, and the scope thereof is determined by the claims that follow.

1. A method of forming a film on a substrate, comprising:
combining a lithium-containing precursor, an iron containing precursor, and an organic solvent to form a deposition mixture;
optionally exposing the deposition mixture to vibrational energy;
applying microwave energy to the deposition mixture to heat the deposition mixture;
optionally exposing the heated deposition mixture to vibrational energy; and
depositing the heated deposition mixture on a substrate to form a film comprising lithium containing nanocrystals.

2. The method of claim 1, wherein the lithium containing precursor is selected from the group comprising: LiH₂PO₄, LiOH, LiNO₃, LiCH₃COO, LiCl, Li₂SO₄, Li₃PO₄, Li(C₅H₈O₂), and combinations thereof.

3. The method of claim 2, wherein the iron containing precursor is selected from the group comprising: iron (III) acetate (Fe(CH₃COO)₃), iron (II) acetate (Fe(CH₃COO)₂), iron (II) sulfate (FeSO₄), iron (III) chloride (FeCl₃), and combinations thereof.

4. The method of claim 3, wherein the organic solvent is selected from the group comprising: water, diethylene glycol, ethylene glycol, dimethyl sulfoxide (DMSO), polyethylene glycol (PEG), and combinations thereof.

5. The method of claim 4, wherein the deposition mixture further comprises a phosphate source selected from the group comprising: ammonium phosphate ((NH₄)₃PO₄)), ((NH₄)₂HPO₄), ((NH₄)₂H₂(PO₄)), phosphoric acid (H₃PO₄), and combinations thereof.

6. The method of claim 5, wherein the deposition mixture further comprises a carbon source selected from the group comprising: glucose (C₆H₁₂O₆), ascorbic acid (C₆H₈O₆), sucrose (C₁₂H₂₂O₁₁), fructose (C₆H₁₂O₆), and combinations thereof.

7. The method of claim 1, wherein the heated deposition mixture is combined with a binding agent prior to depositing the heated deposition mixture on a substrate.

8. The method of claim 7, wherein the binder is selected from the group comprising: polyvinylidene difluoride (PVDF) and water-soluble binders, such as butadiene styrene rubber (BSR).

9. The method of claim 6, wherein the deposition mixture further comprises a surfactant for controlling particle size selected from the group comprising: sodium lauryl sulfate (C₁₂H₂₅SO₄Na) and ammonium lauryl sulfate (CH₃(CH₂)₁₀CH₂OSO₃NH₄).

10. A composition for forming a lithium containing active electrode material having an olivine structure on a substrate, comprising:
a lithium-containing precursor;
an iron containing precursor; and
an organic solvent.

11. The composition of claim 10, wherein the lithium containing precursor is selected from the group comprising: LiH₂PO₄, LiOH, LiNO₃, LiCH₃COO, LiCl, Li₂SO₄, Li₃PO₄, Li(C₅H₈O₂), and combinations thereof.

12. The composition of claim 11, wherein the iron containing precursor is selected from the group comprising: iron (III) acetate (Fe(CH₃COO)₃), iron (II) acetate (Fe(CH₃COO)₂), iron (II) sulfate (FeSO₄), iron (III) chloride (FeCl₃), and combinations thereof.

13. The composition of claim 12, wherein the organic solvent is selected from the group comprising: water, diethylene glycol, ethylene glycol, dimethyl sulfoxide (DMSO), polyethylene glycol (PEG), and combinations thereof.

14. The composition of claim 13, further comprising a phosphate source selected from the group comprising: ammonium phosphate ((NH₄)₃PO₄)), ((NH₄)₂HPO₄), ((NH₄)₂H₂(PO₄)), phosphoric acid (H₃PO₄), and combinations thereof.

15. The composition of claim 14, further comprising a carbon source selected from the group comprising: glucose (C₆H₁₂O₆), ascorbic acid (C₆H₈O₆), sucrose (C₁₂H₂₂O₁₁), fructose (C₆H₁₂O₆), and combinations thereof.

16. The composition of claim 11, further comprising a binding agent.

17. The composition of claim 16, wherein the binder is selected from the group comprising: polyvinylidene difluoride (PVDF) and water-soluble binders, such as butadiene styrene rubber (BSR).

18. The composition of claim 15, further comprising a surfactant for controlling particle size selected from the group comprising: sodium lauryl sulfate (C₁₂H₂₅SO₄Na) and ammonium lauryl sulfate (CH₃(CH₂)₁₀CH₂OSO₃NH₄).

19. The method of claim 1, wherein the deposition mixture further comprises a phosphate containing precursor.

20. The composition of claim 16, further comprising a conductive additive.

21. The composition of claim 20, wherein the conductive additive comprises carbon black.

22. An apparatus for forming a lithium containing active electrode material having an olivine structure on a substrate, comprising:
a processing chamber enclosing a substrate support and a dispenser, the dispenser comprising:
an activation chamber in fluid communication with a precursor source;
a source of electric power coupled to the activation chamber;
a mixing region in fluid communication with the activation chamber for forming a deposition mixture, the mixing region having an exit oriented toward the substrate support;
a lithium-containing precursor source in fluid communication with the mixing region;
an iron containing precursor source in fluid communication with the mixing region; and
an organic solvent in fluid communication with the mixing region.

23. The apparatus of claim 19, wherein the source of electric power is an RF source.
